(19) United States
(12) Patent Application Publication
(10) Pub. No.: US 2014/0346739 A1
(43) Pub. Date: Nov. 27, 2014

(54) Bullet Seal

(71) Applicant: Baker Hughes Incorporated, Houston, TX (US)

(72) Inventors: Sibu Varghese, Houston, TX (US); Goang-Ding Shyu, Houston, TX (US)

(21) Appl. No.: 13/902,363

(22) Filed: May 24, 2013

(51) Int. Cl. F16J 15/16

(52) U.S. Cl. CPC F16J 15/164
USPC 277/529

(57) ABSTRACT

A bullet seal tail section is reconfigured from a groove flanked by tapered surfaces that engage an o-ring seal to an end design on the bullet seal that has tapered surfaces that meet at a first angle and a pin with an end taper that has counterpart surfaces that slope more with respect to an axis of the seal. The o-ring is on an opposite side of the pin from the tail of the bullet seal. Large differentials evenly push out the bullet seal tail and uniformly compress the o-ring for a larger contact area at greater contact force than previously known. The o-ring is reformed into a generally quadrilateral shape from round due to the applied loading.

### FIELD OF THE INVENTION

The field of the invention is bullet seals and more particularly mirror image assemblies separated by an o-ring that abuts a tail of the bullet seal.

### BACKGROUND OF THE INVENTION

FIGS. 1-8 depict the prior art design starting with the no differential pressure condition and concluding with loading to 20,000 PSI in FIG. 7. Opposed bullet seal segments 10 and 12 are shown with their respective tail ends 14 and 16 separated by o-ring 18. In the traditional manner each of the tail ends 14 and 16 define a groove 20 and 22 respectively. Tapered surfaces 24 and 26 extend on opposed sides of groove 22. Since the designs are mirror image only one will be described. At a loading of 250 PSI in FIG. 2 the gaps have closed and the groove 22 is still intact. However, at 1250 PSI as shown in FIG. 3 the groove 22 has collapsed. Thereafter, as shown in FIG. 4 the o-ring 18 begins to more noticeably distort when the loading is increased to 4,000 PSI. The engagement surface 28 of the o-ring 18 starts to decrease as the loading increases in FIGS. 5-7 from 10,000 PSI to 15,000 PSI in FIG. 6 to the level of 20,000 PSI in FIG. 8. The o-ring 18 more visibly distorts out of round as seen in this progression of greater loading. As a result, there is an uneven length of engagement of the sealing surface 30. FIG. 8 illustrates why this happens. Arrow 32 is a horizontal force component acting at a distance 34 from axis 36. This moment causes the groove such as 22 to collapse as shown in the other FIGS. The fact that bullet seals typically operate at elevated temperatures such as about 500 degrees F. only accentuates this effect. What results is a narrow band of peak sealing force at the contact location shown in the circle in FIG. 9. FIG. 10 is a mathematical model illustrating the same contact location and pressure differential and temperature as FIG. 9 but showing computed stress values. These FIGS. Will later be compared against the present invention to illustrate the point that at comparable pressure and temperature loading conditions a larger contact area occurs with the present invention and a higher contact force is attained to enhance sealing integrity.

Those skilled in the art will realize that the prior bullet seal design has been used for decades under the assumption that the interaction of the o-ring seal 18 with the tapered surfaces 24 and 26 will splay the end positions apart into the surrounding sealing surfaces on the inside diameter and the outside diameter. In fact, the groove was made wider to try to get this desired motion in the prior design. Studies have shown that rather than getting the desired effect of the groove, its presence hastened collapse of the sides that define the groove into the grove, which also drew the end on the exterior surface of the bullet seal away from the outer sealing surface or at least reduced the contact stress rather than enhancing it as shown in the present invention.

Those skilled in the art will appreciate that the present invention attains greater contact loading by in essence getting rid of the groove between sloping surfaces and inserting a pin that has sloping surfaces that are at slightly greater angles than the end of the bullet seal. The back of the pin that faces the o-ring is preferably a radial surface. On high loading the o-ring deforms symmetrically with a longer length of engagement of the sealing surface with a higher contact force than the prior design of FIGS. 1-10. The loading at the tail end of the bullet seal is more uniformly distributed which contributes to minimizing or preventing separation of the contact surface from the opposing sealing surface. The offset of the angles on the pin from the opposing tapers at the end of the bullet contribute to the reduction or prevention of separation of the tail end of the bullet seal from the adjacent sealing surface. The offset angles in the range of 1-10 degrees with about 5 degrees preferred results in uniformly pushing the tail end of the bullet seal resulting in doubling the length of the contact area from the prior design. These and other features of the present invention will be more readily apparent to those skilled in the art from a review of the detailed description of the preferred embodiment and the associated drawings while recognizing that the full scope of the invention is to be determined by the appended claims.

### SUMMARY OF THE INVENTION

A bullet seal tail section is reconfigured from a groove flanked by tapered surfaces that engage an o-ring seal to an end design on the bullet seal that has tapered surfaces that meet at a first angle and a pin with an end taper that has counterpart surfaces that slope more with respect to an axis of the seal. The o-ring is on an opposite side of the pin from the tail of the bullet seal. Large differentials evenly push out the bullet seal tail and uniformly compress the o-ring for a larger contact area at greater contact force than previously known. The o-ring is reformed into a generally quadrilateral shape from round due to the applied loading.

### BRIEF DESCRIPTION OF THE DRAWINGS

FIG. 1 is a section view of a prior art design in the run in condition;

FIG. 2 is the view of FIG. 1 subjected to 250 PSI differential pressure;

FIG. 3 is the view of FIG. 2 subjected to 1250 PSI differential pressure;

FIG. 4 is the view of FIG. 3 subjected to 4,000 PSI differential pressure;

FIG. 5 is the view of FIG. 4 subjected to 10,000 PSI differential pressure;

FIG. 6 is the view of FIG. 5 subjected to 15,000 PSI differential pressure;

FIG. 7 is the view of FIG. 6 subjected to 20,000 PSI differential pressure;

FIG. 8 is the view of FIG. 1 subjected to 100 PSI differential pressure and showing force distribution;

FIG. 9 is the view of FIG. 1 subjected to 20,000 PSI differential pressure and showing the reduced engagement length for sealing;

FIG. 10 is the view of FIG. 9 subjected to 20,000 PSI differential pressure showing the decreased zone of maximum contact stress;

FIG. 11 is the design of the present invention subjected to 0 PSI pressure differential;

FIG. 12 is the design of FIG. 11 subjected to 250 PSI differential pressure;

FIG. 13 is the design of FIG. 12 subjected to 1250 PSI differential pressure;

FIG. 14 is the design of FIG. 13 subjected to 4,000 PSI differential pressure;

FIG. 15 is the design of FIG. 14 subjected to 10,000 PSI differential pressure;

FIG. 16 is the design of FIG. 15 subjected to 15,000 PSI differential pressure;

FIG. 17 is the design of FIG. 16 subjected to 20,000 PSI differential pressure;

FIG. 18 is a close up view of the seal of the present invention showing the angular difference between the pin and the tail of the adjacent seal at 100 PSI loading;

FIG. 19 is the view of FIG. 18 at 1000 PSI loading and showing the even force distribution on the tail of the seal;

FIG. 20 shows o-ring deformation at 15,000 PSI loading developing length of sealing engagement;

FIG. 21 is the view of FIG. 20 under 20,000 PSI loading;

FIG. 22 shows contact stresses and length of engagement at 20,000 PSI for the view of FIG. 21.

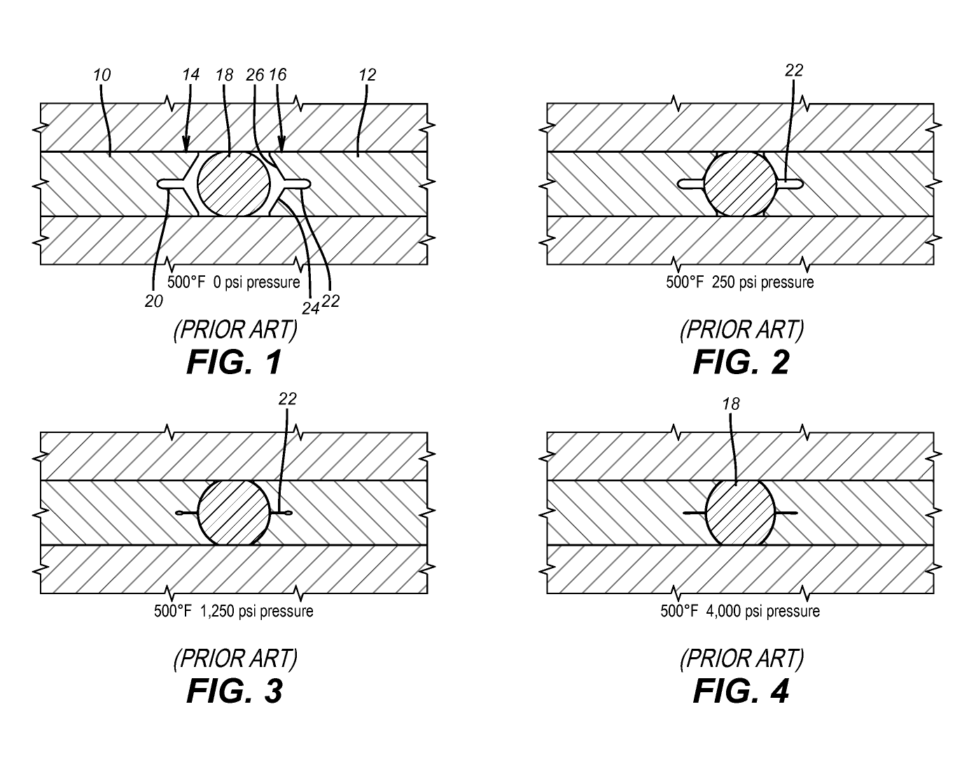

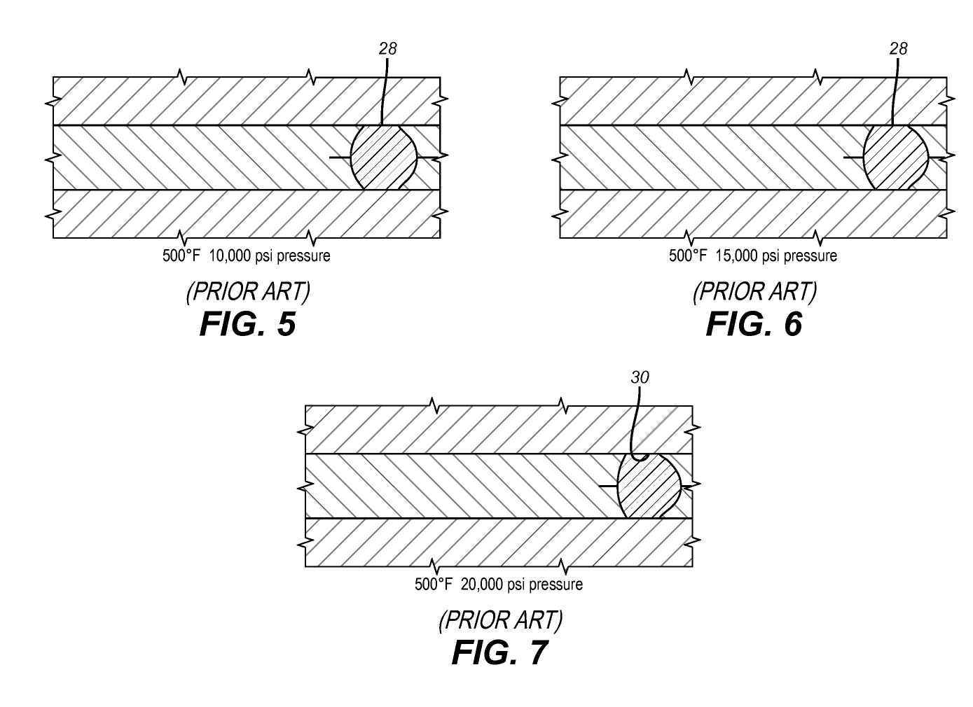

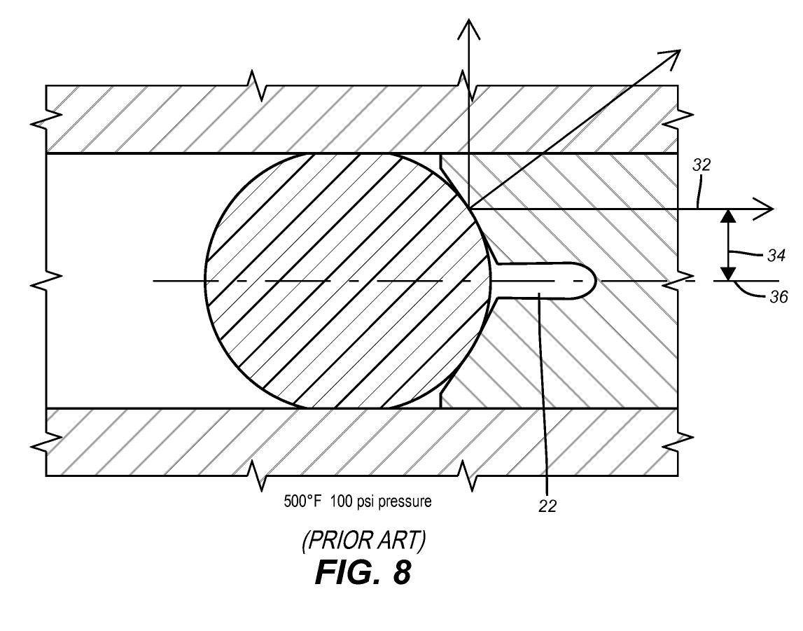

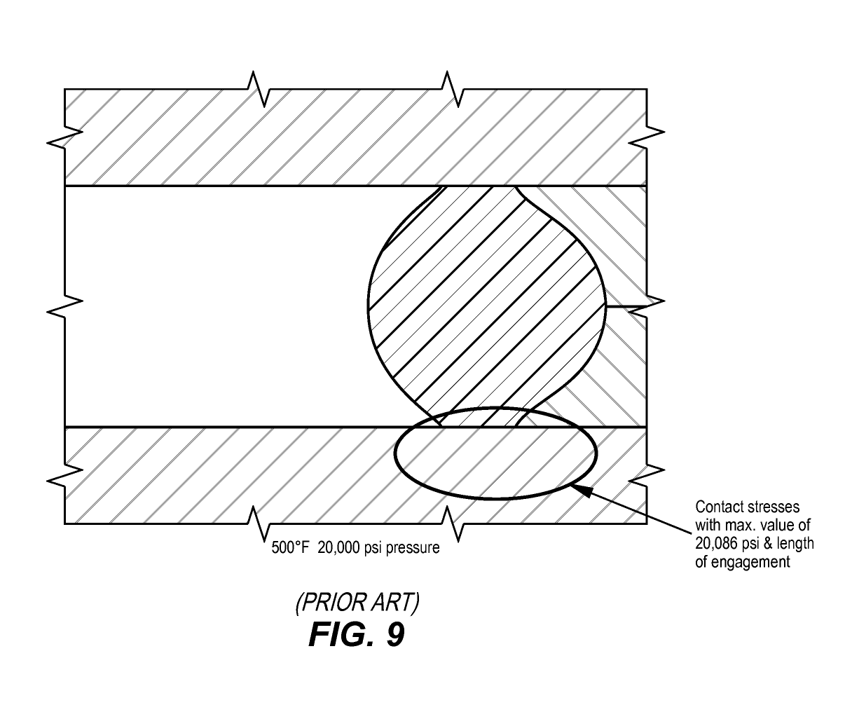

### DETAILED DESCRIPTION OF THE PREFERRED EMBODIMENT

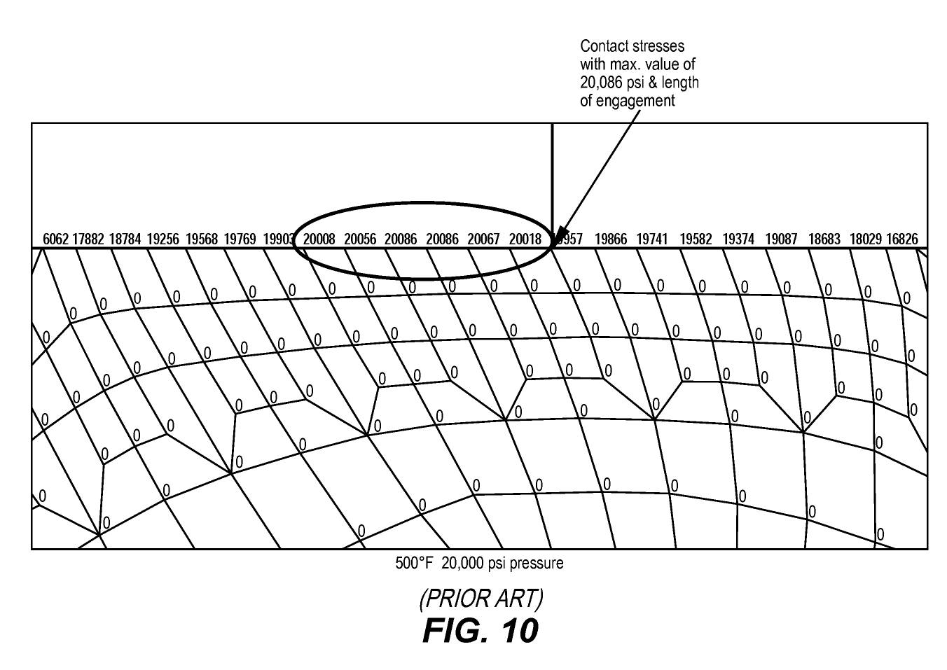

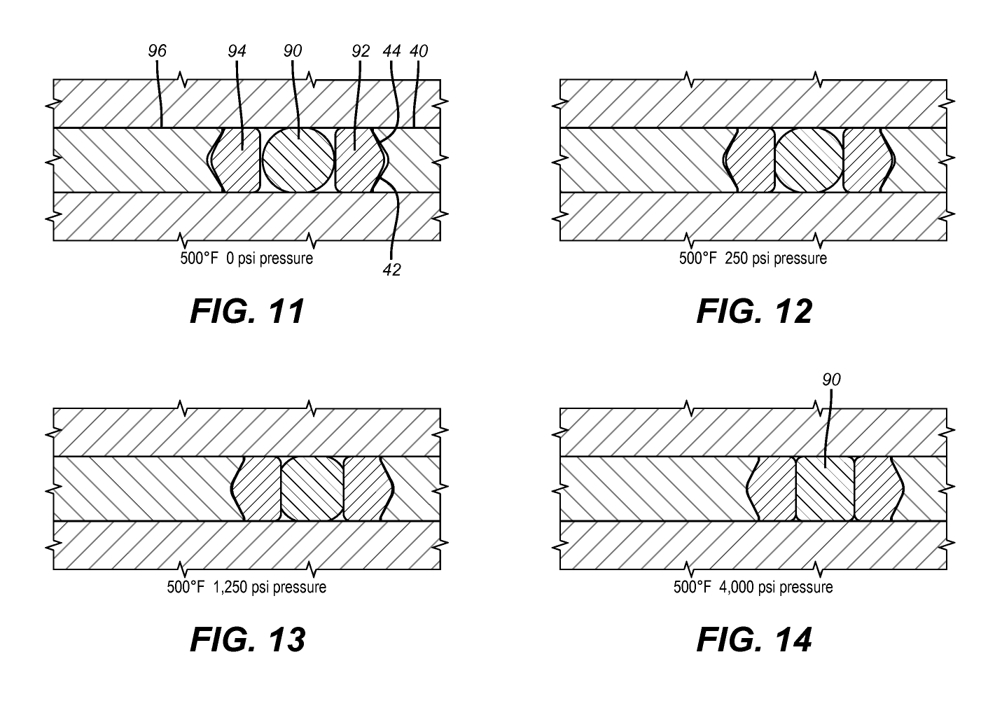

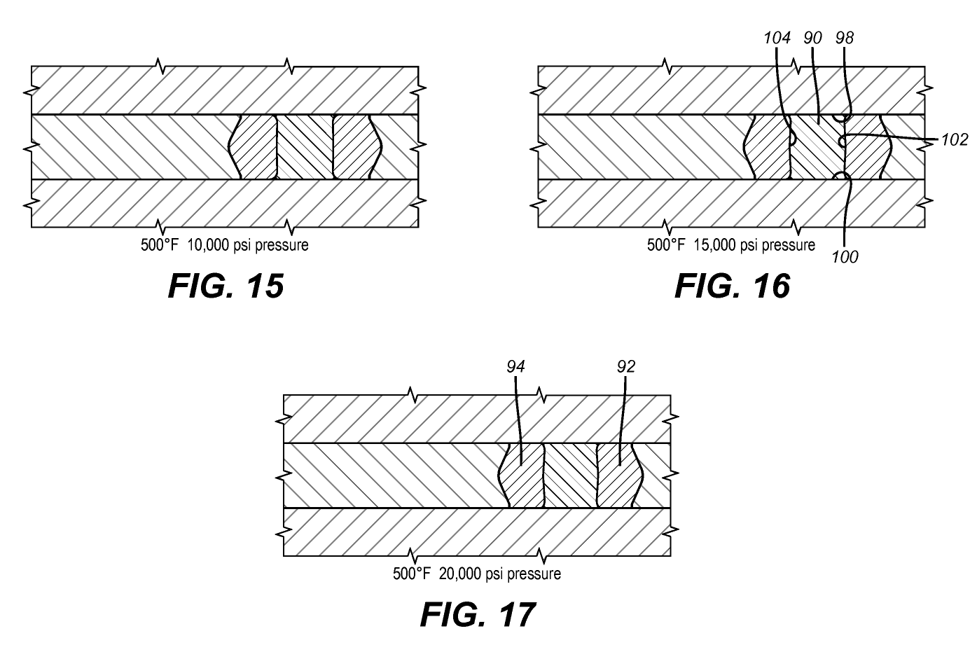

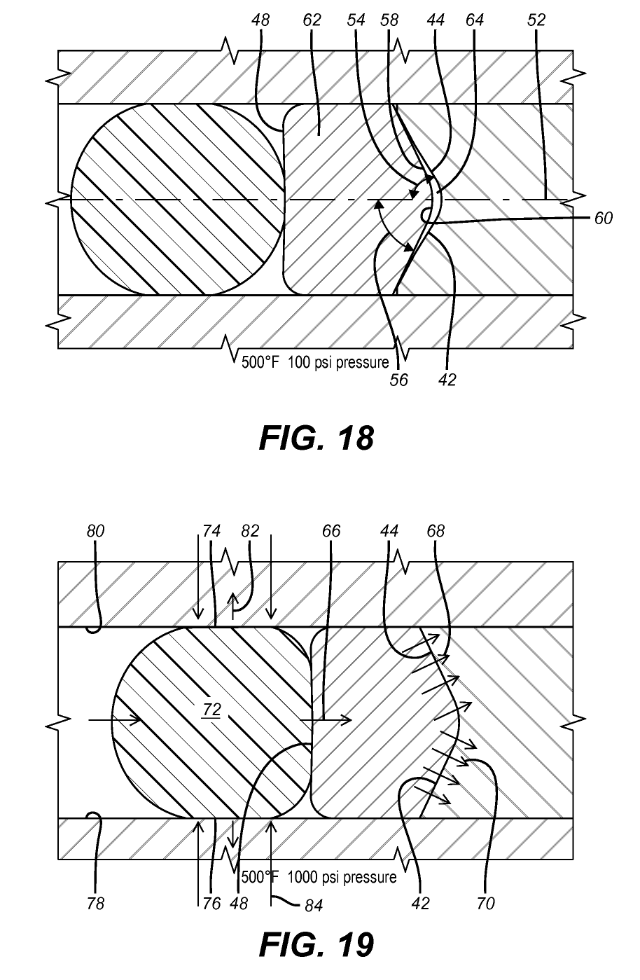

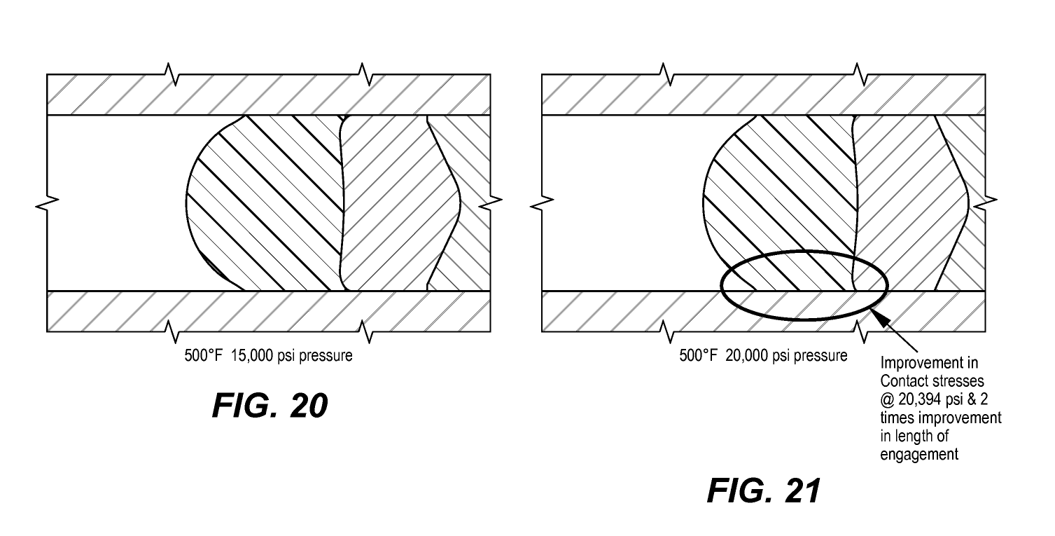

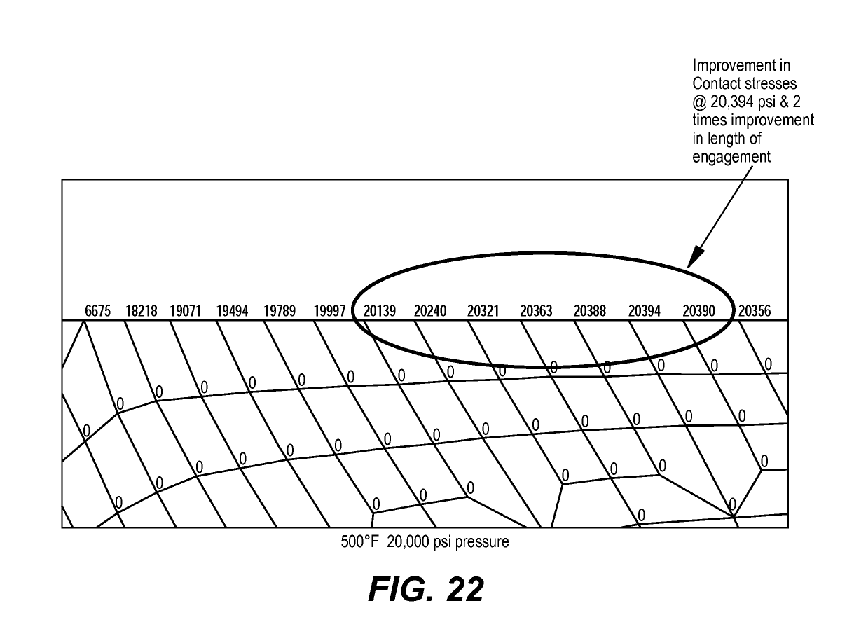

Referring to FIGS. 11-17 it can be seen that the bullet seal 40 has been redesigned to eliminate the deep groove with parallel walls in favor of a more open chevron shape which is defined by end walls 42 and 44. An adjacent pin 46 has a flat back 48 that faces the o-ring 50 and is preferably perpendicular to the axis 52 as better seen in FIG. 18. Surface 48 may have a slight slope or can be formed of multiple surfaces or an arcuate shape without departing from the scope of the invention. Included angle 54 is smaller than included angle 56 formed by surfaces 58 and 60 on the pentagonal shaped pin 62 leaving a gap 64 between the pin 62 and the bullet seal 40 at axis 52 under low load conditions such as 100 PSI that is illustrated in FIG. 18. This angular difference in opposing surfaces that is preferably in the order of about 5 degrees but can vary between 1 and 10 degrees ultimately accounts for even loading on surfaces 42 and 44 in response to a radial force represented by arrow 66 branches into components represented by arrow groups 68 and 70 to result in closing the gap 64 and uniform outward loading to enhance contact stress and contact area. At the same time with the differential at only 1000 PSI note how the o-ring 72 has taken the shape of surface 48 of the pin 62. The o-ring 72 has also started to form an enlarging contact surface 74 and 76 on opposed sealing surfaces 78 and 80. Arrows 82 and 84 respectively represent the loading force from the o-ring 72 and the reaction force from the opposing sealing surfaces. FIGS. 20-22 show what happens at higher pressure loading. The contact stress in FIG. 22 is somewhat higher than the known design shown in FIG. 10 and the contact area is dramatically larger in the order of twice as large. What this means is the present invention results in more reliable sealing as the contact area has doubled for identical loading conditions of 500 degrees F. and 20,000 PSI.

The performance improvement comes from one or more new features not found in the old design. The deep groove with parallel walls such as 20 or 22 has been eliminated in favor of a more broadly open chevron shape using surfaces 40 and 42. There is now a pin with leading surfaces 58 and 60 preferably at a slightly greater angle from the axis 52 than opposing surfaces 42 and 44 on the bullet seal 40. This provides uniform outward loading as shown in FIG. 19 and prevents or minimizes the collapsing of the bullet seal which would otherwise reduce contact sealing area.

FIGS. 11-17 illustrate the mirror image layout with an o-ring 90 straddled by mirror image pins 92 and 94 and further out the opposed bullet seals 40 and 96. As the loading at 500 degrees F. increases the o-ring 90 is reformed into more of a quadrilateral or square shape confined as it is on radially opposite sides by sealing surfaces 98 and 100. In the axial direction the confining surfaces are 102 and 104 of pins 92 and 94 respectively. Here the symmetrical o-ring deformation contributes to a greater sealing contact area when the differential pressures get to the level of 20,000 PSI as illustrated in FIG. 17.

Those skilled in the art will also appreciate that the pins 92 and 94 are annular ring shapes as are the bullet seals such as 40 and of course the o-rings 72 or 90. All fit in an annular gap defined by opposed circular surfaces such as 98 and 100. An assembly can be a mirror image as in FIGS. 11-17 or it can be one directional such as FIGS. 18-21.

The above description is illustrative of the preferred embodiment and many modifications may be made by those skilled in the art without departing from the invention whose scope is to be determined from the literal and equivalent scope of the claims below:

We claim:

1. A bullet seal assembly for an annular space between opposed sealing surfaces, comprising:
at least one bullet seal member having a tail end comprising adjacent bullet seal surfaces;
an o-ring;
at least one pin disposed between said o-ring and said tail end to transmit differential pressure loading on said o-ring to said bullet seal adjacent surfaces in a manner to move said bullet seal adjacent surfaces to the opposed sealing surfaces.

2. The assembly of claim 1, wherein:
said pin comprises adjacent pin surfaces opposed to said adjacent bullet seal surfaces and sloping at a different angle with respect to an axis of said bullet seal than said adjacent bullet seal surfaces.

3. The assembly of claim 2, wherein:
said slope of said adjacent pin surfaces is greater than said slope of said adjacent bullet seal surfaces.

4. The assembly of claim 3, wherein:
the slope difference between said pin adjacent surfaces and said bullet seal adjacent surfaces is in the range of 1-10 degrees.

5. The assembly of claim 4, wherein:
the slope difference between said pin adjacent surfaces and said bullet seal adjacent surfaces is about 5 degrees.

6. The assembly of claim 1, wherein:
said pin comprises a radial surface that abuts said o-ring.

7. The assembly of claim 6, wherein:
said radial surface is oriented substantially perpendicularly to the axis of said bullet seal.

8. The assembly of claim 1, wherein:
said o-ring conforms to the shape of said pin at a contact location therebetween as differential pressure on the assembly is increased.

9. The assembly of claim 1, wherein:
said o-ring transforms from a circular shape in section to a quadrilateral shape on increased differential pressure loading.

10. The assembly of claim 1, wherein:
said pin has a pentagon shape.

11. The assembly of claim 7, wherein:
said pin comprises adjacent pin surfaces opposed to said adjacent bullet seal surfaces and sloping at a different angle with respect to an axis of said bullet seal than said adjacent bullet seal surfaces.

12. The assembly of claim 1, wherein:
said at least one bullet seal comprises a plurality of bullet seals with said tail ends facing each other;
said at least one pin comprises a plurality of pins oriented in mirror image orientation to each other;
said o-ring is disposed between said pins.

13. The assembly of claim 12, wherein:
said pins present radial surfaces to abut said o-ring.

14. The assembly of claim 13, wherein:
said o-ring deforms on increasing pressure differential acting on the assembly by reconfiguring from a round shape in section toward a quadrilateral shape against said radial surfaces and the opposed sealing surfaces.

15. The assembly of claim 1, wherein:
said bullet seal tail end is formed without an axial groove defined by parallel walls.

16. The assembly of claim 1, wherein:
said pin uniformly distributes load to said adjacent bullet seal surfaces toward said opposed sealing surfaces.

17. The assembly of claim 1, wherein:
said o-ring increases contact with said opposed sealing surfaces as pressure differential on the assembly increases.

18. The assembly of claim 1, wherein:
said o-ring has a larger contact area with the opposed sealing surfaces under equivalent differential pressure loading as a bullet seal with an axial groove formed by parallel walls disposed between tapered peripheral surfaces and an adjacent o-ring.
